(19) United States
(12) Patent Application Publication
(10) Pub. No.: US 2025/0086603 A1
(43) Pub. Date: Mar. 13, 2025

(54) MEDIUM PROCESSING METHOD AND MEDIUM PROCESSING SYSTEM

(71) Applicant: Glory Ltd., Hyogo (JP)

(72) Inventors: Junji MASHIMO, Hyogo (JP); Yasushi KIMURA, Hyogo (JP); Zhiyun SU, Hyogo (JP)

(73) Assignee: Glory Ltd., Hyogo (JP)

(21) Appl. No.: 18/823,718

(22) Filed: Sep. 4, 2024

(30) Foreign Application Priority Data
Sep. 8, 2023 (JP) 2023-146220

(51) Int. Cl. G06Q 20/10

(52) U.S. Cl. CPC G06Q 20/1085

(57) ABSTRACT

A medium processing method includes receiving, by a server, a reservation set by a client for a transaction including medium processing by a medium processing apparatus, starting, by the medium processing apparatus, the medium processing corresponding to the transaction related to the reservation based on first information related to the relative locations of the client and the medium processing apparatus, and allowing, by the medium processing apparatus, the client to handle a medium in the medium processing apparatus based on second information related to the relative locations, thereby completing the transaction related to the reservation.

### CROSS-REFERENCE TO RELATED APPLICATION

This application claims priority to Japanese Patent Application No. 2023-146220 filed on Sep. 8, 2023, the entire disclosure of which is incorporated herein by reference.

### BACKGROUND

Japanese Patent No. 6881195 describes a conventional cash processing apparatus. The cash processing apparatus is placed at a back office of a retail store. The cash processing apparatus deposits proceeds from sales, and withdraws change. An operator can make reservation for a transaction using the cash processing apparatus. For example, the operator makes reservation for a transaction of withdrawing change before the opening hours of the store. According to date and time set by the reservation, the cash processing apparatus withdraws cash in advance with a shutter of an outlet closed. The cash processing apparatus opens the shutter after having identified the operator having made reservation. The operator having made reservation can receive cash having already been withdrawn.

Japanese Unexamined Patent Publication No. 2017-10211 describes a conventional management apparatus. The management apparatus manages wait time for an automatic teller machine (ATM). Using a mobile terminal, a user can make reservation for use of the ATM. The management apparatus calculates an expected time at which the user arrives at the ATM, based on location information on the mobile terminal. Moreover, the management apparatus calculates the user's wait time based on the schedule of reservation already made by other users for use of the ATM and the calculated expected time of arrival, and notifies the mobile terminal of the wait time.

### SUMMARY

The technique disclosed here relates to a medium processing method. The medium processing method includes the following steps:
receiving, by a server, a reservation set by a client for a transaction including medium processing by a medium processing apparatus;
starting, by the medium processing apparatus, the medium processing corresponding to the transaction related to the reservation based on first information related to the relative locations of the client and the medium processing apparatus; and
allowing, by the medium processing apparatus, the client to handle a medium in the medium processing apparatus based on second information related to the relative locations, thereby completing the transaction related to the reservation.

### BRIEF DESCRIPTION OF THE DRAWINGS

FIG. 1 shows a medium processing system.

FIG. 2 shows a medium processing apparatus.

FIG. 3 shows a block diagram of the medium processing apparatus.

FIG. 4 shows a banknote unit.

FIG. 5 shows a block diagram of the banknote unit.

FIG. 6 shows a coin unit.

FIG. 7 shows a block diagram of the coin unit.

FIG. 8 shows a coin-roll unit.

FIG. 9 shows a block diagram of the coin-roll unit.

FIG. 10 shows a check unit.

FIG. 11 shows a block diagram of the check unit.

FIG. 12 shows the procedure of a medium processing method.

FIG. 13 shows the procedure of the medium processing method.

FIG. 14 shows a flowchart of control of the medium processing apparatus.

FIG. 15 shows a drop box.

### DETAILED DESCRIPTION

The operator can make reservation for the date and time of execution of the transaction by the conventional cash processing apparatus. There has been demanded improvement in convenience in such a reserved transaction.

The technique disclosed here improves convenience in a system capable of making reservation for a transaction including medium processing by a medium processing apparatus.

The technique disclosed here relates to a medium processing method. The medium processing method includes the following steps:
receiving, by a server, a reservation set by a client for a transaction including medium processing by a medium processing apparatus;
starting, by the medium processing apparatus, the medium processing corresponding to the transaction related to the reservation based on first information related to the relative locations of the client and the medium processing apparatus; and
allowing, by the medium processing apparatus, the client to handle a medium in the medium processing apparatus based on second information related to the relative locations, thereby completing the transaction related to the reservation.

The medium processing apparatus starts the medium processing corresponding to the transaction related to the reservation based on the location of the client having made reservation. For example, in a case where the relative locations of the client and the medium processing apparatus become closer to each other as compared to a preset first distance, the medium processing apparatus may start the medium processing.

Moreover, the medium processing apparatus allows the client to handle the medium in the medium processing apparatus based on the second information related to the relative locations. The client can handle the medium using the medium processing apparatus. The handling of the medium includes at least one of the client taking out the medium dispensed from the medium processing apparatus or the client putting the medium into the medium processing apparatus. The client can smoothly and quickly complete the transaction using the medium processing apparatus. Since the transaction for the client having made reservation is completed smoothly and quickly, the time for which the medium processing apparatus is occupied by the client is short. A next client can promptly start a transaction using the medium processing apparatus. A turnover rate upon user of the medium processing apparatus is enhanced.

The medium processing apparatus starts the medium processing based on the location of the client having made reservation. The client having made reservation is at least near the medium processing apparatus. The client has a high probability that the client operates the medium processing apparatus having started the medium processing. A situation where the medium processing apparatus is left without being operated is less likely to occur. The convenience of the system capable of making reservation for the transaction is improved.

The second information may be acquired at the timing after that of the first information.

After the medium processing apparatus has started the medium processing based on the first information, the medium processing apparatus allows, based on the second information, the client to handle the medium in the medium processing apparatus. Since the medium processing is started before the client handles the medium, the client can smoothly and quickly complete the transaction using the medium processing apparatus.

The relative locations of the client and the medium processing apparatus in the second information may be closer to each other as compared to the relative locations of the client and the medium processing apparatus in the first information.

The medium processing apparatus starts the medium processing when the client having made reservation approaches the medium processing apparatus. Thereafter, the medium processing has been completed at the timing when the client arrives at the location of the medium processing apparatus. Immediately after arrival, the client can handle the medium using the medium processing apparatus.

The transaction may be a withdrawal transaction, and
in the withdrawal transaction, the medium processing apparatus may dispense money to the outside thereof.

The client having made reservation for the withdrawal transaction can be receive, from the medium processing apparatus, money dispensed to the outside of the apparatus.

The medium processing apparatus may start, based on the first information, transporting money from the inside to the outside thereof.

All money to be withdrawn is dispensed to the outside of the apparatus at the timing when the client having made reservation arrives at the location of the medium processing apparatus. The client does not need to wait for the medium processing apparatus to dispense money to the outside of the apparatus at the front of the medium processing apparatus.

The medium processing apparatus may have a holder that holds money to be dispensed to the outside thereof and a shutter that opens and closes an outlet port of the holder, and
the medium processing apparatus may close the shutter while transporting money to the holder, and open the shutter when the client is allowed to take out money from the holder based on the second information.

Since the shutter is closed even after money has been transported to the holder, a client other than the client having made reservation cannot take out the money from the holder. When the client having made reservation arrives at the location of the medium processing apparatus, the shutter is opened. The client can take out the money from the holder. That is, the client is allowed to handle the medium.

The transaction may be a money change transaction, and
in the money change transaction, the medium processing apparatus may take money of the client therein, and dispense money, which is equivalent to the taken money, to the outside thereof.

The client having made reservation for the money change transaction can receive already-dispensed money when putting money targeted for money change into the medium processing apparatus.

The medium processing apparatus may have a feeder that feeds money therein, a dispenser that holds money to be dispensed to the outside thereof, and a shutter that opens and closes an outlet port of the dispenser,
the medium processing apparatus may start transporting money therein to the dispenser based on the first information, and close the shutter while transporting money to the dispenser, and
the medium processing apparatus may allow the client to feed money into the medium processing apparatus through the feeder based on the second information, and open the shutter when the client is allowed to take out money from the dispenser after money has been taken in.

All money to be withdrawn is dispensed to the outside of the apparatus at the timing when the client having made reservation arrives at the location of the medium processing apparatus. The client can take out money from the dispenser immediately after money targeted for money change has been fed into the medium processing apparatus. The client does not need to wait for the medium processing apparatus to dispense money to the outside thereof at the front of the medium processing apparatus.

Since the shutter is closed, a client other than the client having made reservation cannot take out money from the dispenser. The shutter is opened when the client having made reservation put money into the medium processing apparatus. The security of the medium processing apparatus is ensured.

The transaction may be a deposit transaction, and
in the deposit transaction, the medium processing apparatus may take money of the client therein.

The client having made reservation for the deposit transaction can put money targeted for deposit into the medium processing apparatus immediately after having arrived at the location of the medium processing apparatus.

The reservation may include an expected time at which the client handles money using the medium processing apparatus, and the medium processing apparatus may start, before the expected time, the medium processing corresponding to the transaction related to the reservation.

The medium processing apparatus starts the medium processing based on both the location information on the client having made reservation and the expected time of the reservation. The medium processing apparatus can start the medium processing at proper timing.

In a case where the medium processing apparatus executes medium processing related to a second client not related to the reservation before the expected time, the medium processing apparatus may execute the medium processing in a second mode in which the time required for the medium processing is shortened as compared to a normal mode.

The medium processing in the second mode quickly completes the medium processing for the second client. The medium processing apparatus can execute the medium processing related to the reservation at the expected time.

The medium processing apparatus may perform, in the second mode, operation related to the medium processing at a higher speed than that of the normal mode.

The high-speed operation related to the medium processing shortens the time required for the medium processing. The operation related to the medium processing includes, for example, an operation of opening and closing the shutter at a high speed and an operation of increasing a medium transport speed.

Moreover, the high-speed operation related to the medium processing includes, for example, an operation of shortening, as compared to the normal mode, the wait time for waiting for client's operation, such as waiting for the client to put money.

The medium processing apparatus may decrease, in the second mode, the number of items displayed for the second client on a display as compared to the normal mode.

The decrease in the items displayed on the display causes the client to smoothly perform the operation, and therefore, the time required for the medium processing is shortened. The displayed items to be decreased may be items not directly related to execution of the medium processing by the medium processing apparatus. The displayed items to be decreased may include, for example, a displayed item asking the client to input a transaction purpose, such as an item asking the client to select a deposit transaction purpose from options including “deposit of proceeds from sales” and “other deposits.”

The medium processing apparatus may limit, in the second mode, the contents of processing allowed for the second client as compared to the normal mode.

When the contents of the processing allowed for the second client are limited, the time required for the medium processing for the second client is shortened. The limitation on the contents of the processing includes, for example, limitation of continuous execution of two or more transactions by the second client by omitting a step of checking with the second client about the necessity of a subsequent transaction after completion of one transaction. The limitation on the contents of the processing further includes a decrease in the upper limit of the number of times of additional deposit as compared to the normal mode and a decrease in the maximum amount of withdrawal as compared to the normal mode.

The medium processing apparatus may limit a client performing a transaction at the expected time only to the client related to the reservation.

The client having made reservation can perform the transaction using the medium processing apparatus at the expected time.

In a case where the transaction of the client related to the reservation is not completed even after the expected time has passed, the medium processing apparatus may cancel the transaction related to the reservation, and remove the limitation.

In a case where the client having made reservation does not arrive at the medium processing apparatus even after the expected time has passed and the transaction related to the reservation is not completed, use of the medium processing apparatus by a client other than the client having made reservation is limited. In this case, the medium processing apparatus cancels the transaction related to the reservation and removes the limitation so that the client other than the client having made reservation can use the medium processing apparatus. The efficiency of operation of the medium processing apparatus is enhanced.

Note that the time until cancellation of the reserved transaction after the expected time has passed may be set in advance.

The first information and the second information may be acquired using a communication function of a mobile terminal held by the client.

The use of the communication function of the mobile terminal allows the relative locations of the client holding the mobile terminal and the medium processing apparatus to be acquired with favorable accuracy.

The first information may be acquired using a communication function of a mobile terminal held by the client, and the second information may be acquired using a sensor of the medium processing apparatus.

The first information related to the client approaching the medium processing apparatus is acquired using the communication function of the mobile terminal with favorable accuracy. The second information related to the client having arrived at the location of the medium processing apparatus is acquired using the sensor of the medium processing apparatus with favorable accuracy.

The medium processing apparatus may have control circuitry that controls the medium processing apparatus, and based on acquisition of information on the transaction related to the reservation from the server by the control circuitry and acquisition of the first information from the mobile terminal by the control circuitry, the medium processing may be started by the control circuitry.

A medium processing system disclosed here includes
a medium processing apparatus that executes a transaction including medium processing, and
a server that receives a reservation set by a client for the transaction executed by the medium processing apparatus,
the medium processing apparatus starts the medium processing corresponding to the transaction related to the reservation based on first information related to the relative locations of the client and the medium processing apparatus, and
the medium processing apparatus allows the client to handle a medium in the medium processing apparatus based on second information related to the relative locations, thereby completing the transaction related to the reservation.

Since the medium processing apparatus starts the reserved medium processing based on the client location information, the client can smoothly and quickly complete the transaction using the medium processing apparatus. A situation where the medium processing apparatus is left without being operated is less likely to occur. The convenience of the system capable of making reservation for the transaction is improved.

Hereinafter, an embodiment of a medium processing system and a medium processing method will be described with reference to the drawings. The medium processing system and the medium processing method described here are examples.

### (Medium Processing System)

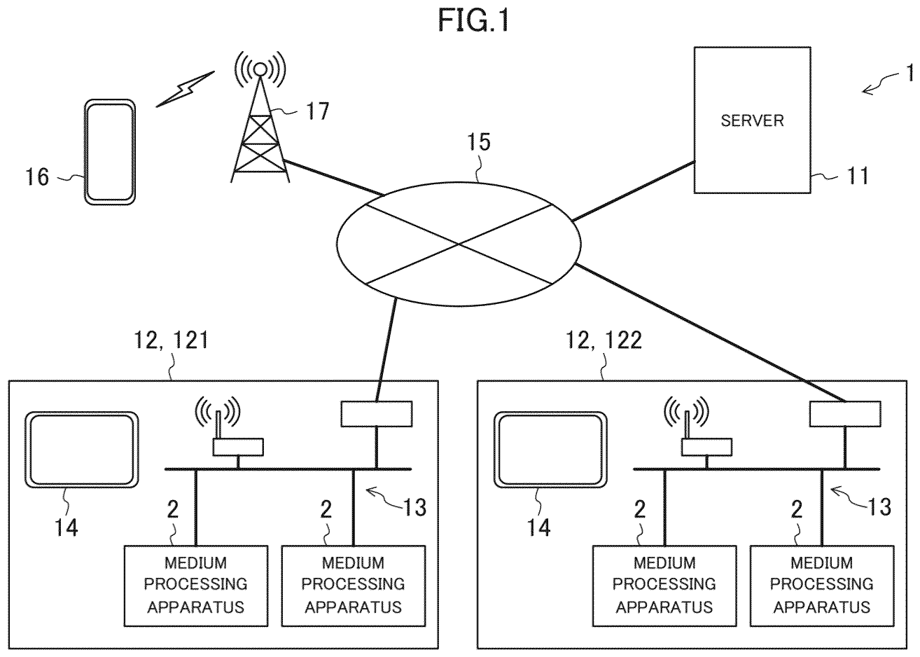

FIG. 1 shows a medium processing system 1 as an example. The medium processing system 1 is a system used by a financial facility for providing a client with a transaction including medium processing by means of a medium processing apparatus 2 placed at a service office 12. The financial facility is, for example, a bank. The financial facility is not limited to the bank. The transaction provided to the client includes at least a deposit transaction, a withdrawal transaction, and a money change transaction.

The deposit transaction is a transaction for depositing money to a client's account. The deposit transaction includes a deposit transaction involving storage of money in the medium processing apparatus 2 and a deposit transaction involving processing of a check by the medium processing apparatus 2. The withdrawal transaction is a transaction for withdrawing money from the medium processing apparatus 2. The withdrawal transaction includes a withdrawal transaction for withdrawing money from the client's account and a withdrawal transaction involving processing of a check by the medium processing apparatus 2. The money change transaction is a transaction for storing money in the medium processing apparatus 2 and dispensing money equivalent to the stored money from the medium processing apparatus 2.

The medium processing system 1 provides the client with a service allowing transaction reservation. The client can make reservation for the transaction made using the medium processing apparatus 2 before visiting the service office 12. The medium processing system 1 provides the client with an advantage that the client can smoothly make the transaction using the medium processing apparatus 2. Moreover, the medium processing system 1 provides the financial facility with an advantage that the occupancy time of the medium processing apparatus 2 is shortened and a work efficiency is enhanced.

The medium processing system 1 includes a server 11. The server 11 manages the transaction reservation. The server 11 is connected to the medium processing apparatus 2 via a wide area network 15. The wide area network 15 is, for example, the Internet. As described later, the server 11 has a function of receiving the transaction reservation from the client and a function of providing the medium processing apparatus 2 with the received transaction reservation.

The medium processing system 1 includes the medium processing apparatus 2. The medium processing apparatus 2 is an apparatus that processes a medium. The medium includes at least one of a banknote, a coin, or a check. As described later, the medium processing system 1 described here as an example is capable of processing all a banknote, a coin, and a check. The medium processing apparatus 2 is operated by the client of the financial facility. A person in charge, for example a teller, of the service office 12 may operate the medium processing apparatus 2 for assisting the client.

The medium processing apparatus 2 is located in the service office 12 of the financial facility. The medium processing system 1 of FIG. 1 includes two service offices 12 which are a first service office 121 and a second service office 122. The number of service offices 12 included in the medium processing system 1 is not limited. Hereinafter, in a case where the first service office 121 and the second service office 122 are not distinguished from each other, these service offices will be merely referred to as a “service office(s) 12.”

Two medium processing apparatuses 2 are placed at the service office 12. The number of medium processing apparatuses 2 placed at the service office 12 is not limited. The medium processing apparatus 2 is connected to a local area network (LAN) 13 built in the service office 12. The LAN 13 includes a wired LAN and a wireless LAN. The medium processing apparatus 2 is connected to the wide area network 15 via the LAN 13. Details of the medium processing apparatus 2 will be described later.

A tablet 14 is connected to the LAN 13. The tablet 14 is an information providing terminal. The person in charge of the service office 12 uses the tablet 14. The person in charge can acquire various types of information via the tablet 14.

A client terminal 16 is connected to the wide area network 15. The client can make the transaction reservation via the client terminal 16.

The client terminal 16 has (1) a data communication function of transmitting the transaction reservation to the server 11 and (2) a function of providing the medium processing apparatus 2 with client location information.

A smartphone or a personal computer (PC) has the function (1). The smartphone or the PC is one example of the client terminal 16. The smartphone can transmit the transaction reservation to the server 11 via a mobile phone base station 17 and the wide area network 15. The smartphone or the PC can transmit the transaction reservation to the server 11 by connecting the smartphone or the PC itself to the wide area network 15 via near field communication such as Wi-Fi (registered trademark) by means of the communication function.

With the function (2), the smartphone can also provide the medium processing apparatus 2 with the location information by means of a global positioning system (GPS) function and the communication function. The communication function of the smartphone in this case is not limited to communication via the mobile phone base station 17, and includes near field communication. The near field communication includes Wi-Fi. Moreover, the smartphone can provide the medium processing apparatus 2 with the client location information, i.e., location information on the smartphone carried by the client, by communicating with the medium processing apparatus 2 via, e.g., Bluetooth (registered trademark). Further, the smartphone can provide the medium processing apparatus 2 with information, which indicates that the smartphone carried by the client is near the medium processing apparatus 2, by communicating with the medium processing apparatus 2 via near field communication (NFC). The near field communication includes Bluetooth and NFC. An electronic tag that transmits a Bluetooth signal directly or indirectly communicates with the medium processing apparatus 2, thereby implementing the function (2).

The client terminal 16 implementing the functions (1), (2) is not limited to one device. The client may make the transaction reservation via, e.g., the PC, and thereafter, may visit the service office 12 with the smartphone. As described later, the smartphone provides the medium processing apparatus 2 with the location information so that the client can execute the transaction using the medium processing apparatus 2. Alternatively, the client may make the transaction reservation via, e.g., the smartphone, and thereafter, may visit the service office 12 with the electronic tag. The electronic tag provides the medium processing apparatus 2 with the location information so that the client can execute the transaction using the medium processing apparatus 2.

### (Medium Processing Apparatus)

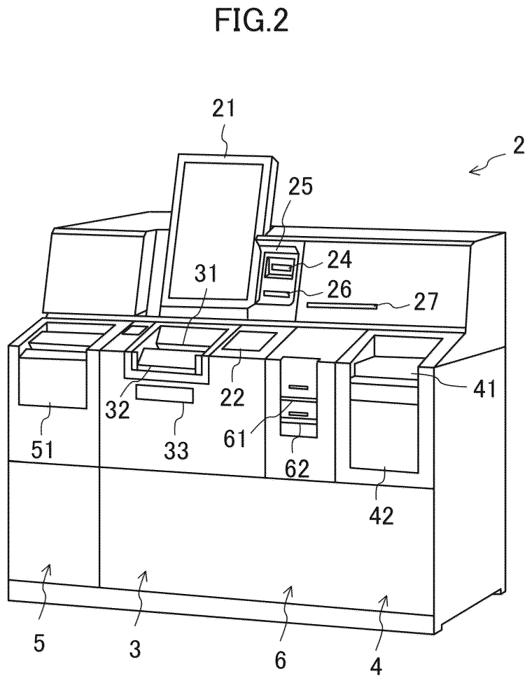

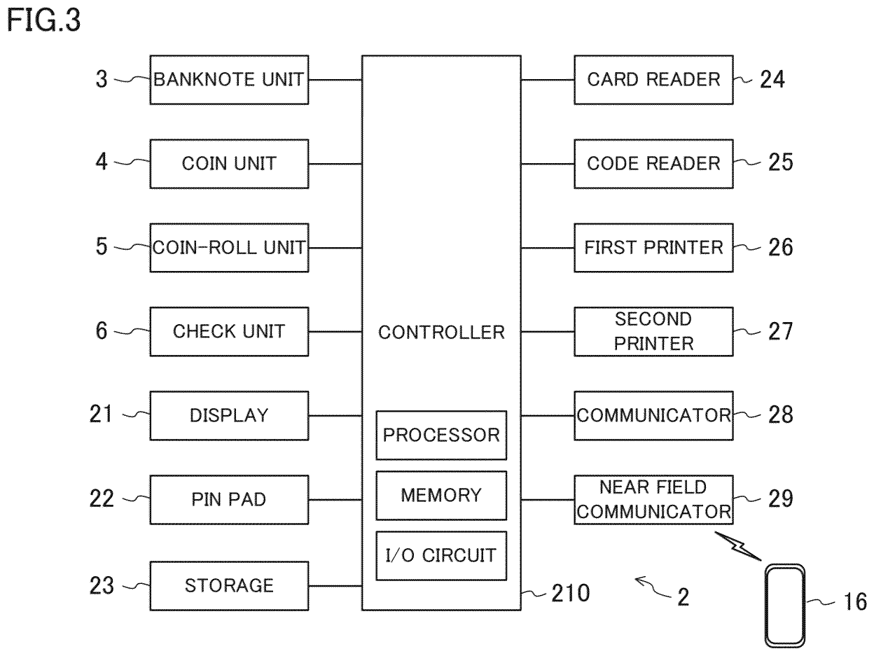

FIG. 2 shows the appearance of the medium processing apparatus 2. FIG. 3 is a block diagram of the medium processing apparatus 2. The medium processing apparatus 2 executes medium processing related to the transaction. A medium targeted for the processing of the medium processing apparatus 2 includes money and a check. The money includes a banknote and a coin. The medium processing apparatus 2 shown in FIGS. 2 and 3 is an example, and for example, may be an apparatus that processes only a banknote.

The medium processing apparatus 2 includes a banknote unit 3. The banknote unit 3 processes a banknote, more precisely a loose note.

The medium processing apparatus 2 includes a coin unit 4. The coin unit 4 processes a coin, more precisely a loose coin. Note that in the medium processing apparatus 2, the coin unit 4 may be omitted.

The medium processing apparatus 2 includes a coin-roll unit 5. The coin-roll unit 5 withdraws a roll of coins. The roll of coins includes a plurality of loose coins wrapped with stacked on each other. Note that in the medium processing apparatus 2, the coin-roll unit 5 may be omitted.

The medium processing apparatus 2 includes a check unit 6. The check unit 6 processes a check. Note that in the medium processing apparatus 2, the check unit 6 may be omitted.

The medium processing apparatus 2 includes a display 21. The display 21 provides information to the client operating the medium processing apparatus 2. The display 21 may be a touch panel display. The client can operate the medium processing apparatus 2 using the display 21.

The medium processing apparatus 2 includes a personal identification number (PIN) pad 22. The client of the medium processing apparatus inputs PIN information using the PIN pad 22. The PIN information includes, for example, a number, a symbol, and an alphabet.

The medium processing apparatus 2 includes a storage 23. The storage 23 stores various types of information necessary for operation of the medium processing apparatus 2.

The medium processing apparatus 2 includes a card reader 24. The card reader 24 reads a client's card such as a cash card. The medium processing apparatus 2 includes a code reader 25. The code reader 25 reads a bar code or a two-dimensional code. As described later, the code reader 25 may read, using a camera, a two-dimensional code, such as a QR code (registered trademark), displayed on a screen of the smartphone of the client to identify the client having made the transaction reservation.

The medium processing apparatus 2 includes a first printer 26. The first printer 26 prints transaction contents on a receipt. The medium processing apparatus 2 includes a second printer 27. The second printer 27 prints the transaction contents on paper.

The medium processing apparatus 2 includes a communicator 28. The communicator 28 communicates with the server 11 via the LAN 13 and the wide area network 15.

The medium processing apparatus 2 includes a near field communicator 29. The near field communicator 29 communicates with the client terminal 16 via the near field communication.

The medium processing apparatus 2 includes a controller 210. The controller 210 includes at least a processor, a memory, and an I/O circuit. The processor executes a program. The memory stores a program and data for operating the medium processing apparatus 2. The memory is, for example, a random access memory (RAM) and/or a read only memory (ROM). The I/O circuit exchanges an electric signal between the controller 210 and a device connected to the controller 210. The controller 210 outputs a control signal to the device, and accordingly, the medium processing apparatus 2 operates.

### (Banknote Unit)

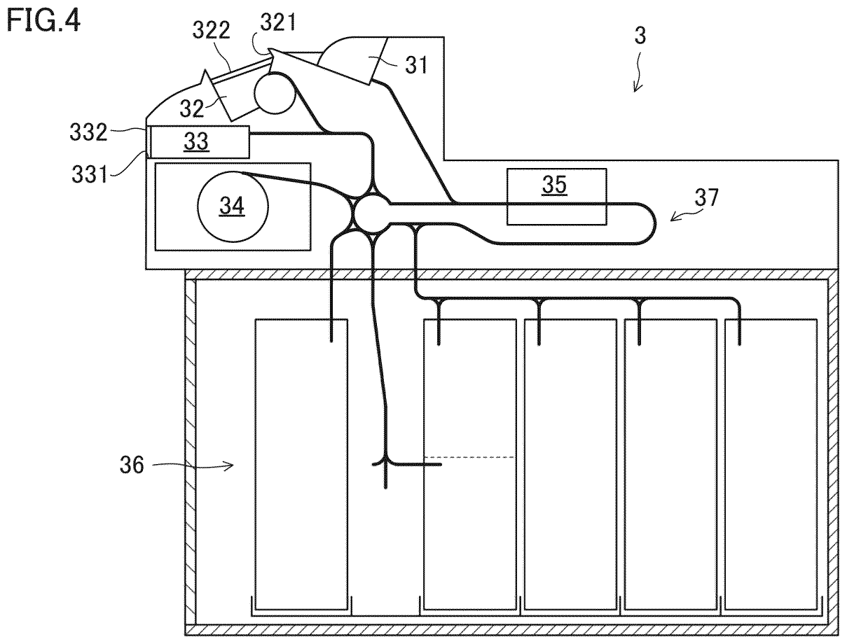

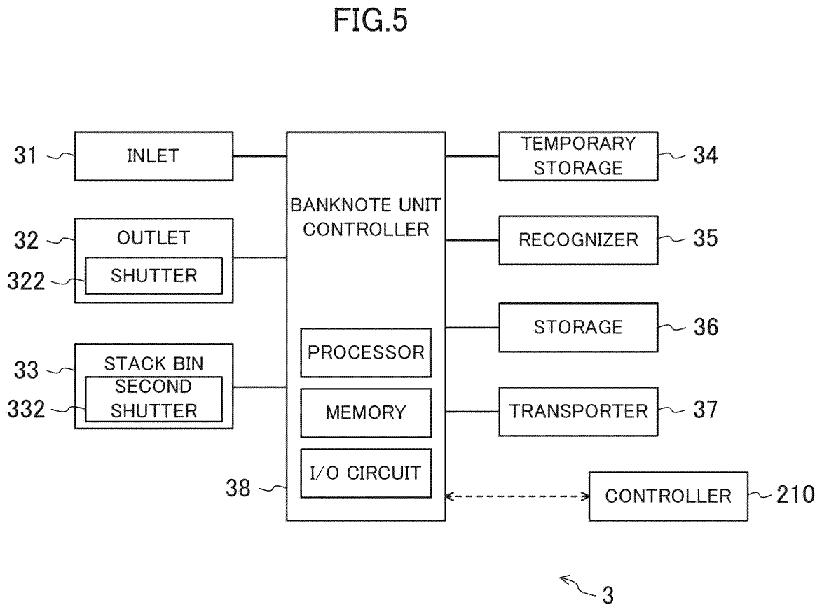

FIG. 4 shows the banknote unit 3. FIG. 5 is a block diagram of the banknote unit 3. The loose banknote processing executed by the banknote unit 3 includes at least banknote deposit processing, banknote withdrawal processing, and money change processing. In the deposit processing, the banknote unit 3 takes a banknote therein. In the withdrawal processing, the banknote unit 3 dispenses a banknote to the outside thereof. In the money change processing, the banknote unit 3 performs at least one of processing of taking a banknote therein or processing of dispensing a banknote to the outside thereof.

The banknote unit 3 has an inlet 31. The inlet 31 feeds a banknote into the unit.

The banknote unit 3 has an outlet 32. The outlet 32 feeds a banknote out of the unit. The outlet 32 is one example of a holder or a dispenser that holds a banknote to be fed out of the apparatus. The outlet 32 has a shutter 322 that opens and closes an outlet port 321. When the shutter 322 is closed, the client cannot take out a banknote dispensed to the outlet 32. When the shutter 322 is opened, the client can take out a banknote dispensed to the outlet 32.

The banknote unit 3 has a stack bin 33. The stack bin 33 stores a banknote. The stack bin 33 has a second shutter 332 that opens and closes a second outlet port 331. When the second shutter 332 opens the second outlet port 331, the client can take out a banknote stored in the stack bin 33 through the second outlet port 331. As described later, the stack bin 33 may store a banknote when the banknote unit 3 executes the medium processing related to the reserved transaction.

The banknote unit 3 has a temporary storage 34. The temporary storage 34 stores a banknote, and feeds out the stored banknote.

The banknote unit 3 has a recognizer 35. The recognizer 35 recognizes a banknote to be deposited or a banknote to be withdrawn. The recognizer 35 recognizes a banknote to acquire information on, e.g., a currency, a denomination, a serial number, or authenticity.

The banknote unit 3 has a storage 36. The storage 36 stores a banknote to be deposited. The storage 36 feeds out a banknote to be withdrawn. The storage 36 includes a plurality of cassettes. The plurality of cassettes stores a banknote, for example, according to a denomination.

The banknote unit 3 has a transporter 37. The transporter 37 transports a banknote one by one. The transporter 37 has a transport path connecting the plurality of devices.

The banknote unit 3 has a banknote unit controller 38. The banknote unit controller 38 includes at least a processor, a memory, and an I/O circuit. Based on the control signal from the controller 210 of the medium processing apparatus 2, the banknote unit controller 38 outputs a control signal to the device, and accordingly, the banknote unit 3 operates.

The banknote unit 3 executes the following medium processing in the deposit transaction. The inlet 31 feeds a banknote to be deposited into the unit. The recognizer 35 recognizes the banknote. The transporter 37 transports the banknote to the storage 36 if the banknote is normal. The storage 36 stores the normal banknote. The transporter 37 transports the banknote to the outlet 32 if the banknote is rejected. The rejected banknote is returned to the client through the outlet 32. Note that in the deposit transaction, the transporter 37 may transport the normal banknote to the temporary storage 34. The temporary storage 34 temporarily stores the banknote. When the client accepts the deposit transaction, the temporary storage 34 feeds out the banknote. The fed banknote is stored in the storage 36. When the client cancels the deposit transaction, the banknote fed out of the temporary storage 34 is transported to the outlet 32. The client operates the display 21 or the PIN pad 22 to accept the deposit transaction or the withdrawal transaction.

The banknote unit 3 executes the following medium processing in the withdrawal transaction. The storage 36 feeds out a banknote to be withdrawn. The recognizer 35 recognizes the banknote. The transporter 37 transports the banknote to the outlet 32 if the banknote is normal. The shutter 322 of the outlet 32 closes the outlet port 321. The transporter 37 transports the banknote to the temporary storage 34 if the banknote is not normal. The temporary storage 34 stores the banknote which is not normal. After all the banknotes to be withdrawn have been transported to the outlet 32, the shutter 322 opens the outlet port 321 except for the case of later-described reservation processing. After the client has taken out the banknotes from the outlet 32, the temporary storage 34 feeds out the banknote. The banknote fed out of the temporary storage 34 is stored in the storage 36.

In the money change transaction, the banknote unit 3 executes combined medium processing of the medium processing in the deposit transaction and the medium processing in the withdrawal transaction. The inlet 31 feeds a banknote to be deposited into the unit. After recognition by the recognizer 35, the storage 36 stores the banknote. The storage 36 feeds out a banknote to be withdrawn. After recognition by the recognizer 35, the banknote is transported to the outlet 32. Note that in the money change transaction, the banknote unit 3 may take a banknote therein while the coin unit 4 or the coin-roll unit 5 dispenses a coin or a roll of coins to the outside thereof. Moreover, in the money change transaction, the coin unit 4 takes a coin therein while the banknote unit 3 dispenses a banknote to the outside thereof.

### (Coin Unit)

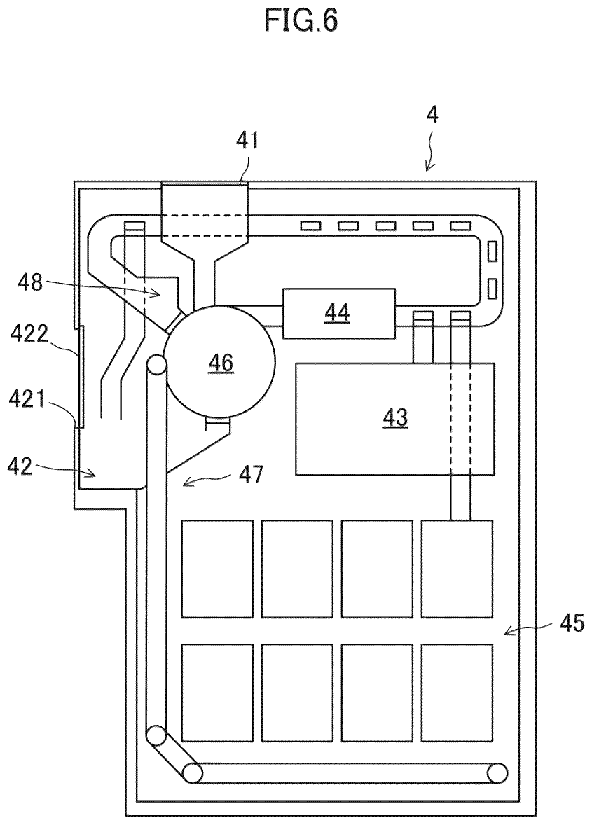

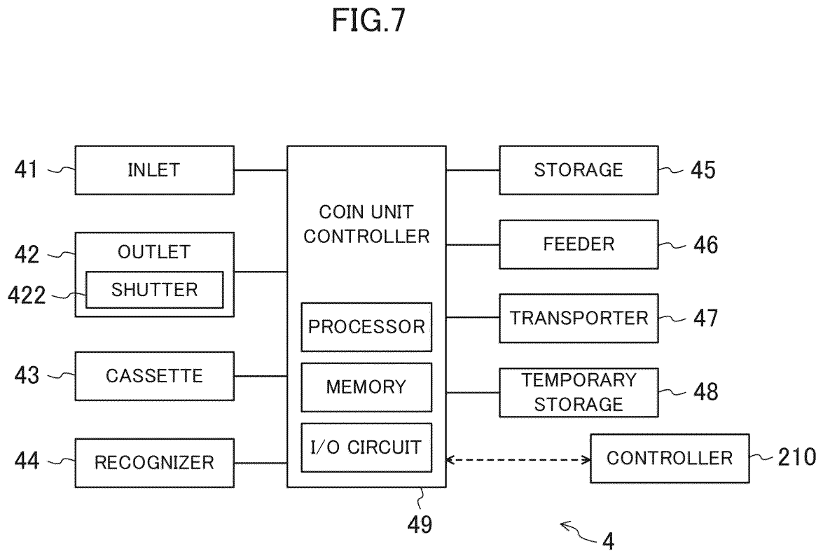

FIG. 6 shows the coin unit 4. FIG. 7 is a block diagram of the coin unit 4. The loose coin processing executed by the coin unit 4 includes at least one of coin deposit processing, coin withdrawal processing, and money change processing. In the deposit processing, the coin unit 4 takes a coin therein. In the withdrawal processing, the coin unit 4 dispenses a coin to the outside thereof. In the money change processing, the coin unit 4 performs at least one of processing of taking a coin therein or processing of dispensing a coin to the outside thereof.

The coin unit 4 has an inlet 41. The inlet 41 feeds a coin into the unit.

The coin unit 4 has an outlet 42. The outlet 42 dispenses a coin out of the unit. The outlet 42 is one example of a holder or a dispenser that holds money to be dispensed out of the apparatus. The outlet 42 has a shutter 422 that opens and closes an outlet port 421. When the shutter 422 is closed, the client cannot take out a coin dispensed to the outlet 42. When the shutter 422 is opened, the client can take out a coin dispensed to the outlet 42.

The coin unit 4 has a cassette 43. The cassette 43 is attachable to and detachable from the coin unit 4. The cassette 43 stores and feeds out a coin. The cassette 43 is used for collecting a coin from the coin unit 4 and refilling the coin unit 4 with a coin.

The coin unit 4 has a recognizer 44. The recognizer 44 recognizes a coin to be deposited or a coin to be withdrawn.

The coin unit 4 has a storage 45. The storage 45 stores a coin to be deposited. The storage 45 feeds out a coin to be withdrawn. The storage 45 includes a plurality of cassettes. The plurality of cassettes stores a coin, for example, according to a denomination.

The coin unit 4 has a feeder 46. The feeder 46 feeds out, to the recognizer 44, a coin put into the inlet 41 one by one. The feeder 46 feeds out, to the recognizer 44, a coin fed out of the storage 45 one by one.

The coin unit 4 has a transporter 47. The transporter 47 transports a coin. The transporter 47 has a transport path connecting the plurality of devices.

The coin unit 4 has a temporary storage 48. The temporary storage 48 temporarily stores a coin which is not normal in coin withdrawal.

The coin unit 4 has a coin unit controller 49. The coin unit controller 49 includes at least a processor, a memory, and an I/O circuit. Based on the control signal from the controller 210 of the medium processing apparatus 2, the coin unit controller 49 outputs a control signal to the device, and accordingly, the coin unit 4 operates.

The coin unit 4 executes the following medium processing in the deposit transaction. A coin putted through the inlet 41 reaches the feeder 46. The feeder 46 feeds the coin to the recognizer 44 one by one. The recognizer 44 recognizes the coin. The transporter 47 transports the coin to the storage 45 if the coin is normal. The storage 45 stores the normal coin. The transporter 47 transports the coin to the outlet 42 if the coin is rejected. The rejected coin is returned to the client through the outlet 42.

The coin unit 4 executes the following medium processing in the withdrawal transaction. The storage 45 feeds out a coin to be withdrawn. The transporter 47 transports the coin to the outlet 42 through the feeder 46 and the recognizer 44. The shutter 422 of the outlet 42 closes the outlet port 421. After all the coins to be withdrawn have been transported to the outlet 42, the shutter 422 opens the outlet port 421.

In the money change transaction, the coin unit 4 executes combined medium processing of the medium processing in the deposit transaction and the medium processing in the withdrawal transaction. The inlet 41 feeds a coin to be deposited into the unit. After recognition by the recognizer 44, the storage 45 stores the coin. The storage 45 feeds out a coin to be withdrawn. The coin is transported to the outlet 42.

### (Coin-Roll Unit)

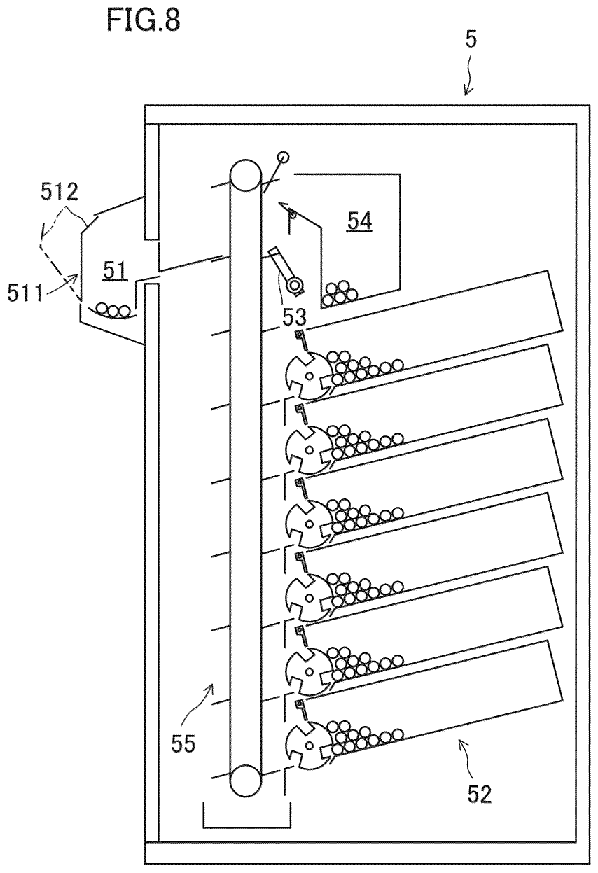

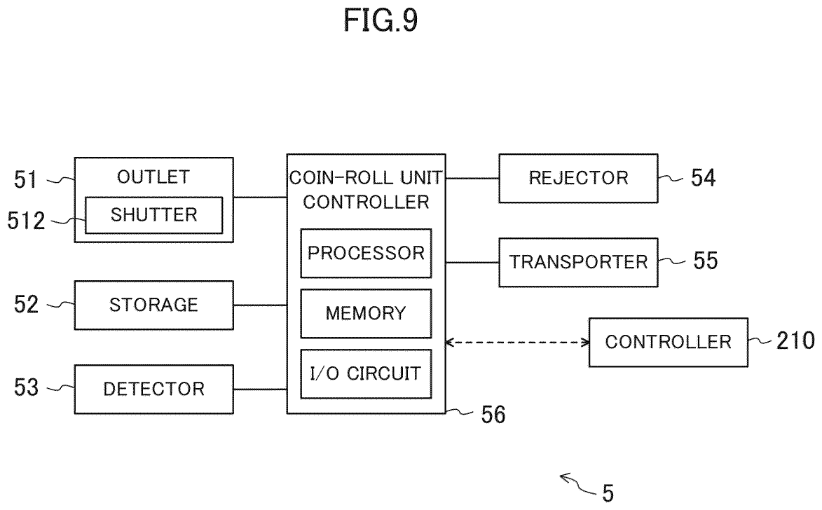

FIG. 8 shows the coin-roll unit 5. FIG. 9 is a block diagram of the coin-roll unit 5. The coin-roll processing executed by the coin-roll unit 5 includes at least one of coin-roll withdrawal processing and money change processing. In the withdrawal processing, the coin-roll unit 5 dispenses a roll of coins to the outside thereof. In the money change processing, the coin-roll unit 5 dispenses a roll of coins to the outside thereof in response to the banknote unit 3 or the coin unit 4 taking money therein.

The coin-roll unit 5 has an outlet 51. The outlet 51 dispenses a roll of coins out of the unit. The outlet 51 is one example of a holder or a dispenser that holds money to be dispensed out of the apparatus. The outlet 51 has a shutter 512 that opens and closes an outlet port 511. When the shutter 512 is closed, the client cannot take out a roll of coins dispensed to the outlet 51. When the shutter 512 is opened, the client can take out a roll of coins dispensed to the outlet 51.

The coin-roll unit 5 has a storage 52. The storage 52 feeds out a roll of coins to be withdrawn. The storage 52 includes a plurality of cassettes. The plurality of cassettes stores a roll of coins, for example, according to a denomination.

The coin-roll unit 5 has a detector 53. The detector 53 detects a roll of coins which cannot be withdrawn.

The coin-roll unit 5 has a rejector 54. The rejector 54 stores a roll of coins which cannot be withdrawn.

The coin-roll unit 5 has a transporter 55. The transporter 55 transports a roll of coins.

The coin-roll unit 5 has a coin-roll unit controller 56. The coin-roll unit controller 56 includes at least a processor, a memory, and an I/O circuit. Based on the control signal from the controller 210 of the medium processing apparatus 2, the coin-roll unit controller 56 outputs a control signal to the device, and accordingly, the coin-roll unit 5 operates.

The coin-roll unit 5 executes the following medium processing in the withdrawal transaction or the money change transaction. The storage 52 feeds out a roll of coins to be withdrawn. The transporter 55 transports the roll of coins to the outlet 51. The shutter 512 of the outlet 51 closes the outlet port 511. After all the rolls of coins to be withdrawn have been transported to the outlet 51, the shutter 512 opens the outlet port 511.

### (Check Unit)

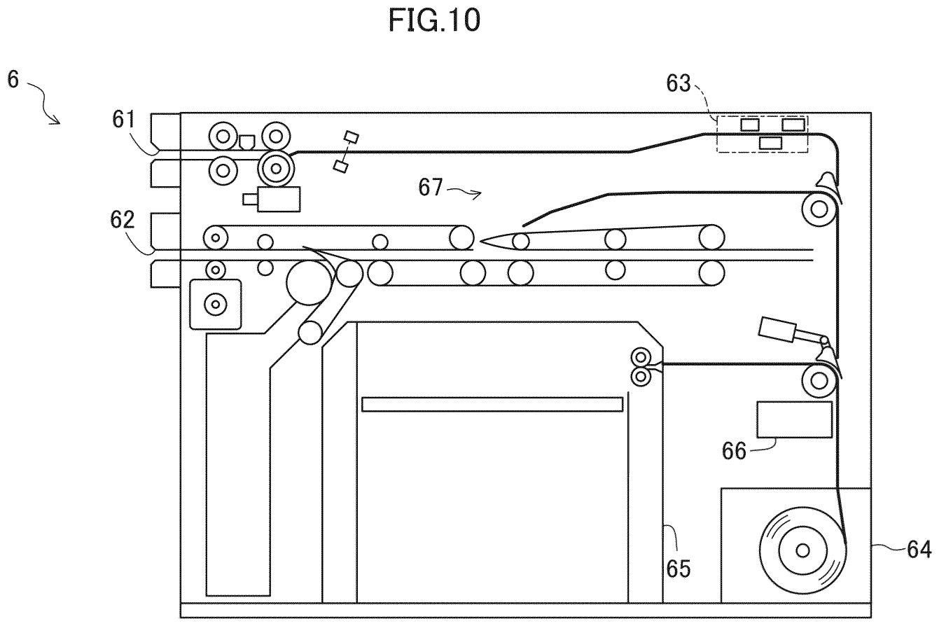

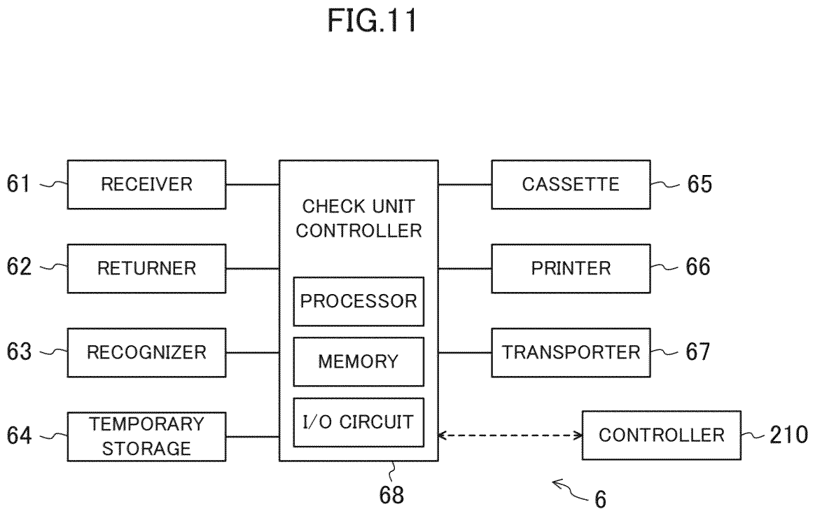

FIG. 10 shows the check unit 6. FIG. 11 is a block diagram of the check unit 6. The check processing executed by the check unit 6 includes check receiving processing. In the receiving processing, the check unit 6 takes a check therein. In response to the receiving processing by the check unit 6, the banknote unit 3, the coin unit 4, and/or the coin-roll unit 5 may execute the withdrawal processing.

The check unit 6 has a receiver 61. The receiver 61 feeds a check into the unit.

The check unit 6 has a returner 62. The returner 62 dispenses a rejected check out of the unit.

The check unit 6 has a recognizer 63. The recognizer 63 recognizes whether or not a check is receivable.

The check unit 6 has a temporary storage 64. The temporary storage 64 temporarily stores a check recognized by the recognizer 63. Moreover, the temporary storage 64 feeds out a stored check.

The check unit 6 has a cassette 65. The cassette 65 stores a receivable check. The cassette 65 is attachable to and detachable from the check unit 6.

The check unit 6 has a printer 66. The printer 66 prints an endorsement on a check stored in the cassette 65.

The check unit 6 has a transporter 67. The transporter 67 transports a check. The transporter 67 has a transport path connecting the plurality of devices.

The check unit 6 has a check unit controller 68. The check unit controller 68 includes at least a processor, a memory, and an I/O circuit. Based on the control signal from the controller 210 of the medium processing apparatus 2, the check unit controller 68 outputs a control signal to the device, and accordingly, the check unit 6 operates.

In receiving transaction, the check unit 6 executes the following medium processing. The receiver 61 feeds a check into the unit. The recognizer 63 recognizes the check. The transporter 67 transports the check to the temporary storage 64. The temporary storage 64 stores the check. When the client performs approval operation related to the check, the temporary storage 64 feeds out the check. The printer 66 prints an endorsement on the check if the check is receivable, and the transporter 67 transports the printed check to the cassette 65. The cassette 65 stores the check. The transporter 67 transports the check to the returner 62 if the check is not receivable.

### (Procedure of Medium Processing in Medium Processing System)

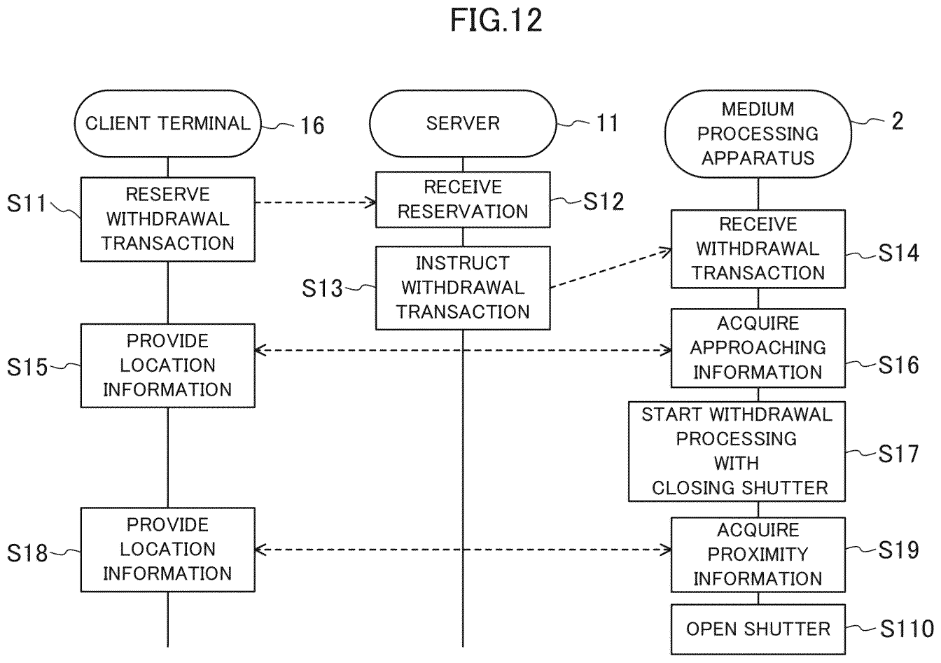

As described above, the medium processing system 1 receives the transaction reservation. Hereinafter, the procedure of reservation transaction executed by the medium processing system 1 will be described with reference to FIG. 12. FIG. 12 shows operation steps of each of the client terminal 16, the server 11, and the medium processing apparatus 2 in a case where the client makes reservation for the withdrawal transaction.

First, in Step S11, the client makes reservation for the withdrawal transaction using the client terminal 16. The client specifies at least (1) information identifying the client making the reservation, (2) the type of transaction to be reserved, (3) the contents of the transaction, and (4) a service office to which the client will visit.

The information identifying the client includes, for example, information on an account in client's name and later-described information on the client terminal 16 carried by the client. The client selects, as the type of transaction, at least one of the deposit transaction, the withdrawal transaction, or the money change transaction. The client specifies, as the contents of the withdrawal transaction, the amount of money to be withdrawn, the denomination of money to be withdrawn, or the denomination and number of rolls of coins to be withdrawn, for example. The client may specify transaction using a check as the contents of the transaction. In a case where the client makes reservation for the transaction using the check, the client may input information on the check in Step S11. The input of the information on the check may include imaging of the check. In Step S11, the client may further specify the expected time of the visit to the service office 12, i.e., the expected time of the transaction.

These contents can be specified using a web browser installed in the client terminal 16 or an application provided by the financial facility. Here, the client terminal 16 transmits the information on the reservation for the withdrawal transaction to the server 11 via the wide area network 15, as one example.

In Step S12, the server 11 receives the reservation for the withdrawal transaction from the client terminal 16. Subsequently, in Step S13, the server 11 instructs the medium processing apparatus 2 of the specified service office 12 to execute the withdrawal transaction. Note that in a case where the plurality of medium processing apparatuses 2 is placed at the specified service office 12, the server 11 may instruct any one of the medium processing apparatuses 2 to execute the withdrawal transaction. For example, a particular medium processing apparatus 2 of the plurality of medium processing apparatuses 2 may be a medium processing apparatus 2 dedicated to execution of the medium processing related to the reserved transaction. Alternatively, the server 11 may instruct a management apparatus that manages the plurality of medium processing apparatuses 2 to execute the withdrawal transaction. In this case, the management apparatus may determine the medium processing apparatus 2 executing the medium processing related to the reserved transaction at the timing of acquiring client approaching information, as described later. Alternatively, the person in charge of the service office 12 operating the tablet 14 may select, via operation of the tablet 14, the medium processing apparatus 2 executing the medium processing related to the reserved transaction. In Step S14, the medium processing apparatus 2 receives the instruction from the server 11, i.e., the instruction to execute the withdrawal transaction.

The client makes reservation for the transaction using the client terminal 16, and thereafter, visits the specified service office 12 with the client terminal 16. Via the near field communication between the client terminal 16 and the medium processing apparatus 2, the client terminal 16 provides the medium processing apparatus 2 with the client location information in Step S15, and the medium processing apparatus 2 acquires the client location information, i.e., information indicating that the client approaches the medium processing apparatus 2, in Step S16. The approaching information corresponds to first information related to the relative locations of the client and the medium processing apparatus 2. As described above, the medium processing apparatus 2 may communicate, for example, with the client terminal 16 via Bluetooth, thereby acquiring the approaching information. Note that by communication via Bluetooth, the medium processing apparatus 2 can detect the client terminal 16 at a location substantially 1000 m apart from the medium processing apparatus 2. A distance X1 (m) between the medium processing apparatus 2 and the client terminal 16, with which the processing of Step S15 is executable, may be set within a range of 1000 (m)≥X1 (m).

In Step S17, the medium processing apparatus 2 having acquired the approaching information starts the medium processing related to the specified transaction. Here, the medium processing apparatus 2 starts the withdrawal processing. At this time, the unit necessary for executing the processing received in Step S12 operates. That is, the storage 36, the storage 45, and/or the storage 52 of the banknote unit 3, the coin unit 4, and/or the coin-roll unit 5 feed out money to be withdrawn, and the transporter 37, the transporter 47, and/or the transporter 55 transport the fed money to the outlet 32, the outlet 42, and/or the outlet 51. At this time, the outlet 32, the outlet 42, and/or the outlet 51 close the shutter 322, the shutter 422, and/or the shutter 512. The outlet 32, the outlet 42, and/or the outlet 51 hold the money to be withdrawn.

After Step S15, the client arrives at the location of the medium processing apparatus 2. Via the near field communication between the client terminal 16 and the medium processing apparatus 2, the client terminal 16 provides the medium processing apparatus 2 with the client location information in Step S18. For example, the client may put the client terminal 16 on a predetermined location on the medium processing apparatus 2, and in this manner, the client terminal 16 may provide the medium processing apparatus 2 with the location information via NFC. In Step S19, the medium processing apparatus 2 acquires the provided proximity information. Alternatively, the code reader 25 of the medium processing apparatus 2 may read the code displayed on the screen of the client terminal 16, and in this manner, the client terminal 16 may provide the location information in Step S18 and the medium processing apparatus 2 may acquire the proximity information in Step S19. Note that in a case where the processing of Step S18 is executed using Bluetooth as in the processing of S15, a distance X2 (m) between the medium processing apparatus 2 and the client terminal 16, with which the processing of Step S18 is executable, may be set in a range of X1 (m)>X2 (m).

The proximity information corresponds to second information acquired at the timing after that of the first information. The relative locations of the client and the medium processing apparatus 2 in the proximity information are closer to each other as compared to the relative locations of the client and the medium processing apparatus 2 in the approaching information. Acquisition of the proximity information with the code reader 25 corresponds to acquisition of the second information with a sensor of the medium processing apparatus 2.

The medium processing apparatus 2 acquires the proximity information, thereby determining that the client having made reservation has arrived at the location of the medium processing apparatus 2. In Step S110, the medium processing apparatus 2 opens the shutter 322, the shutter 422, and/or the shutter 512 of the outlet 32, the outlet 42, and/or the outlet 51. At the front of the medium processing apparatus 2, the client can take out money already held in the outlet 32, the outlet 42, and/or the outlet 51 without waiting for the medium processing apparatus 2 to transport money to the outlet 32, the outlet 42, and/or the outlet 51. Immediately after the client has arrived at the location of the medium processing apparatus 2, the client can smoothly and quickly complete the withdrawal transaction using the medium processing apparatus 2. Moreover, the time for which the medium processing apparatus 2 is occupied by the client is shortened, and therefore, a next client can promptly start a transaction using the medium processing apparatus 2. A turnover rate upon use of the medium processing apparatus 2 is enhanced.

The medium processing apparatus 2 starts the medium processing based on the location of the client having made reservation. The client having made reservation is at least near the medium processing apparatus 2. The client has a high probability that the client operates the medium processing apparatus 2 having started the medium processing. A situation where the medium processing apparatus 2 is left without being operated is less likely to occur. The convenience of the system capable of making reservation for the transaction is improved.

When the medium processing apparatus 2 dispenses the medium to be withdrawn to the outlet 32, the outlet 42, and/or the outlet 51, the shutter 322, the shutter 422, and/or the shutter 512 are closed. A client other than the client having made reservation cannot take out money from the outlet 32, the outlet 42, and/or the outlet 51. When the client having made reservation arrives at the location of the medium processing apparatus 2, the shutter 322, the shutter 422, and/or the shutter 512 are opened. This client can take out money from the outlet 32, the outlet 42, and/or the outlet 51. The medium processing system 1 can ensure security in the reversed transaction.

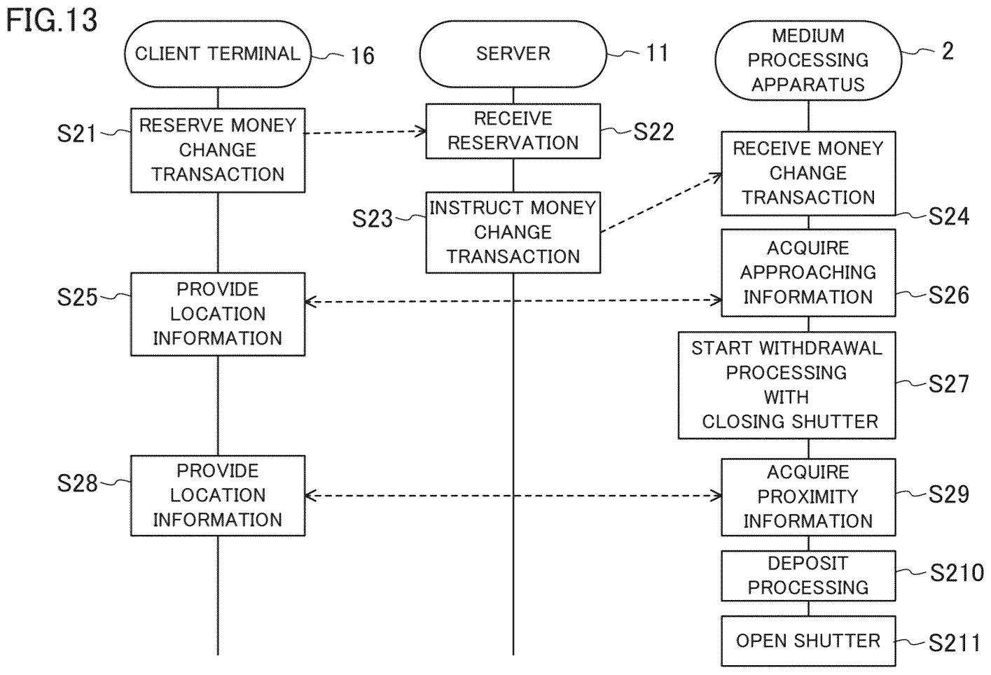

FIG. 13 shows operation steps of each of the client terminal 16, the server 11, and the medium processing apparatus 2 in a case where the client makes reservation for the money change transaction.

First, in Step S21, the client makes reservation for the money change transaction using the client terminal 16. The client terminal 16 transmits information on the reservation for the money change transaction to the server 11 via the wide area network 15.

In Step S22, the server 11 receives the reservation for the money change transaction from the client terminal 16. Subsequently, in Step S23, the server 11 instructs the medium processing apparatus 2 of the specified service office 12 to execute the money change transaction. In Step S24, the medium processing apparatus 2 receives the instruction to execute the money change transaction from the server 11.

After the client has visited the service office 12, the client terminal 16 provides, in Step S25, the medium processing apparatus 2 with the client location information via the near field communication between the client terminal 16 and the medium processing apparatus 2. In Step S26, the medium processing apparatus 2 acquires the client approaching information.

In Step S27, the medium processing apparatus 2 having acquired the approaching information starts the medium processing related to the specified transaction. Here, the medium processing apparatus 2 starts the withdrawal processing related to the money change transaction. The storage 36, the storage 45, and/or the storage 52 of the banknote unit 3, the coin unit 4, and/or the coin-roll unit 5 feed out money to be withdrawn, and the transporter 37, the transporter 47, and/or the transporter 55 transports the fed money to the outlet 32, the outlet 42, and/or the outlet 51. At this time, the outlet 32, the outlet 42, and/or the outlet 51 close the shutter 322, the shutter 422, and/or the shutter 512. The outlet 32, the outlet 42, and/or the outlet 51 hold the money to be withdrawn.

When the client arrives at the location of the medium processing apparatus 2, the client terminal 16 provides, in Step S28, the medium processing apparatus 2 with the client location information via the near field communication between the client terminal 16 and the medium processing apparatus 2. In Step S29, the medium processing apparatus 2 acquires the provided proximity information.

After acquisition of the proximity information, the medium processing apparatus 2 prompts the client to deposit money related to the money change transaction. The client puts the money into the inlet 31 and/or the inlet 41 of the banknote unit 3 and/or the coin unit 4. In Step S210, the banknote unit 3 and/or the coin unit 4 performs the deposit processing. As described above, the banknote unit 3 stores a banknote fed out of the inlet 31 in the storage 36 after recognition by the recognizer 35. The coin unit 4 stores a coin injected into the feeder 46 through the inlet 41 in the storage 45 after recognition by the recognizer 44.

In some cases, in the deposit processing by the banknote unit 3, the outlet 32 of the banknote unit 3 already holds a banknote to be withdrawn in the money change transaction. A banknote recognized as a rejected banknote by the recognizer 35 cannot be transported to the outlet 32. The transporter 37 of the banknote unit 3 may transport a rejected banknote to the stack bin 33. The banknote unit 3 can return a rejected banknote to the client through the second outlet port 331 of the stack bin 33.

After completion of the deposit processing by the medium processing apparatus 2, the medium processing apparatus 2 opens, in Step S211, the shutter 322, the shutter 422, and/or the shutter 512 of the outlet 32, the outlet 42, and/or the outlet 51. The client can take out, without waiting for the medium processing apparatus 2 to transport money to the outlet 32, the outlet 42, and/or the outlet 51, money from the outlet 32, the outlet 42, and/or the outlet 51 immediately after money related to the money change transaction has been deposited. After the client has arrived at the location of the medium processing apparatus 2, the client can smoothly and quickly complete the money change transaction using the medium processing apparatus 2. Moreover, the time for which the medium processing apparatus 2 is occupied by the client is shortened, and therefore, a next client can promptly start a transaction using the medium processing apparatus 2. The turnover rate upon use of the medium processing apparatus 2 is enhanced.

In the money change transaction, the medium processing apparatus 2 also starts the medium processing based on the location of the client having made reservation. The client having made reservation is at least near the medium processing apparatus 2. The client has a high probability that the client operates the medium processing apparatus 2 having started the medium processing. A situation where the medium processing apparatus 2 is left without being operated is less likely to occur. The convenience of the system capable of making reservation for the transaction is improved.

In the money change transaction, the medium processing apparatus 2 also closes the shutter 322, the shutter 422, and/or the shutter 512 when money to be withdrawn is dispensed to the outlet 32, the outlet 42, and/or the outlet 51. A client other than the client having made reservation cannot take out money from the outlet 32, the outlet 42, and/or the outlet 51. The medium processing system 1 can ensure the security in the reserved transaction.

Note that in a case where the client makes reservation for a withdrawal transaction involving a check, the medium processing system 1 operates according to the procedure of FIG. 13. That is, the medium processing apparatus 2 performs check receiving processing instead of the deposit processing in Step S210.

In a case where the client makes reservation for the deposit transaction, the medium processing system 1 operates according to the procedure of FIG. 12. After the medium processing apparatus 2 has received an instruction to execute the deposit transaction from the server 11, the medium processing apparatus 2 starts preparing for the processing related to the deposit transaction in Step S17 when acquiring the approaching information from the client terminal 16. Thereafter, the medium processing apparatus 2 performs the processing related to the deposit transaction in Step S110 when acquiring the proximity information from the client terminal 16. After the client has arrived at the location of the medium processing apparatus 2, the client can promptly start the deposit transaction using the medium processing apparatus 2.

In a case where the expected time is specified, the medium processing apparatus 2 may acquire the client approaching information based on the client location information and the expected time, and may start the medium processing related to the reservation before the expected time. The medium processing apparatus 2 can start the medium processing at proper timing in consideration of the expected time.

Note that in the above-described medium processing system 1, the medium processing apparatus 2 acquires, in Step S16 or Step S26, the proximity information from the client terminal 16 via the near field communicator 29 or the code reader 25. The medium processing apparatus 2 may detect, using the sensor, that the client has arrived at the location of the medium processing apparatus 2. The medium processing apparatus 2 can use, as the sensor, a human sensor or a range sensor, for example. Note that in a case where the medium processing apparatus 2 has detected, using the human sensor or the range sensor, that the client had arrived at the location of the medium processing apparatus 2, the medium processing apparatus 2 may identify whether or not this client is one having made reservation. Such identification is executed, for example, in such a manner that client information stored in the cash card (or bank card) or the client terminal 16 is read by the medium processing system 1. Such identification execution enhances the security of the medium processing system 1.

After the medium processing apparatus 2 has started the withdrawal processing in Step S17 or Step S27, the proximity information may not be able to be acquired in Step S19 or Step S29 even after a lapse of predetermined time. For example, this is because the client having made reservation has visited the service office 12, but has left the service office 12 without completing the transaction. Since the outlet 32, the outlet 42, and/or the outlet 51 of the medium processing apparatus 2 hold money, a client other than the client having made reservation cannot use the medium processing apparatus 2. In this case, the medium processing system 1 may notify, as cancellation processing, the person in charge of the financial facility via the tablet 14. The cancellation processing may be executed, for example, after a lapse of 15 minutes after the reservation time in a case where the reservation time of the transaction has been set. The person in charge having received the notification may perform predetermined operation on the medium processing apparatus 2 to take out money held in the outlet 32, the outlet 42, and/or the outlet 51 and return the taken money into the medium processing apparatus 2. In a case where the outlet 32, the outlet 42, and/or the outlet 51 of the medium processing apparatus 2 have a retract function, the outlet 32, the outlet 42, and/or the outlet 51 may take, using the retract function, held money into the apparatus after a lapse of predetermined time in a state of the money being held.

After money held in the outlet 32, the outlet 42, and/or the outlet 51 has been taken out, the medium processing system 1 may perform the following processing.

The medium processing system 1 notifies the client terminal 16 to visit a counter of the service office 12. The person in charge deposits taken money with the counter. At the counter of the service office 12, the client can receive the money related to the reserved withdrawal transaction.

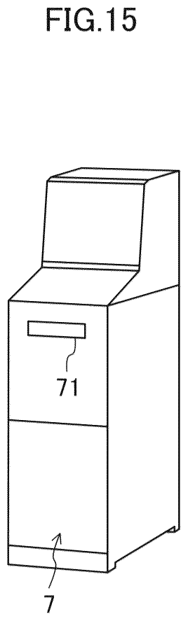

Note that instead of depositing money with the counter, in a case where the medium processing apparatus 2 has a collection unit (i.e., drop box), the person in charge may inject taken money into the collection unit. In this case, the medium processing system 1 may notify the client terminal 16 that the reserved transaction has been cancelled. Note that the drop box 7 is an apparatus including an inlet port 71 for injecting, e.g., money as shown in FIG. 15 and can be included in the medium processing apparatus 2. The drop box 7 may be disposed, for example, adjacent to the side of the coin unit 4 shown in FIG. 2.

The medium processing system 1 may cause the client having made reservation to select how to handle the reserved transaction via the client terminal 16. Examples of options include (1) an option of changing the date and time of the reservation, (2) an option of canceling the reservation, and (3) an option of delivering withdrawn money to the client. In the case of (1) the option of changing the date and time of the reservation, money taken out of the medium processing apparatus 2 may be deposited with the counter of the service office 12 as described above. In the case of (2) the option of canceling the reservation, money taken out of the medium processing apparatus 2 may be returned into the medium processing apparatus 2 or be injected into the collection unit. In the case of (3) the option of delivering the withdrawn money to the client, the client may pay for a delivery fee.

### (Control of Medium Processing Apparatus)

The medium processing apparatus 2 needs to execute the reserved transaction at the timing when the client having made reservation visits the service office 12 or at the expected time of the reservation. Meanwhile, the medium processing apparatus 2 also executes the medium processing related to a transaction by a client having visited the service office 12 and not having made reservation. The medium processing apparatus 2 may execute, in a second mode, medium processing related to a second client not related to the reservation such that the transaction reserved at the expected time is executed preferentially.

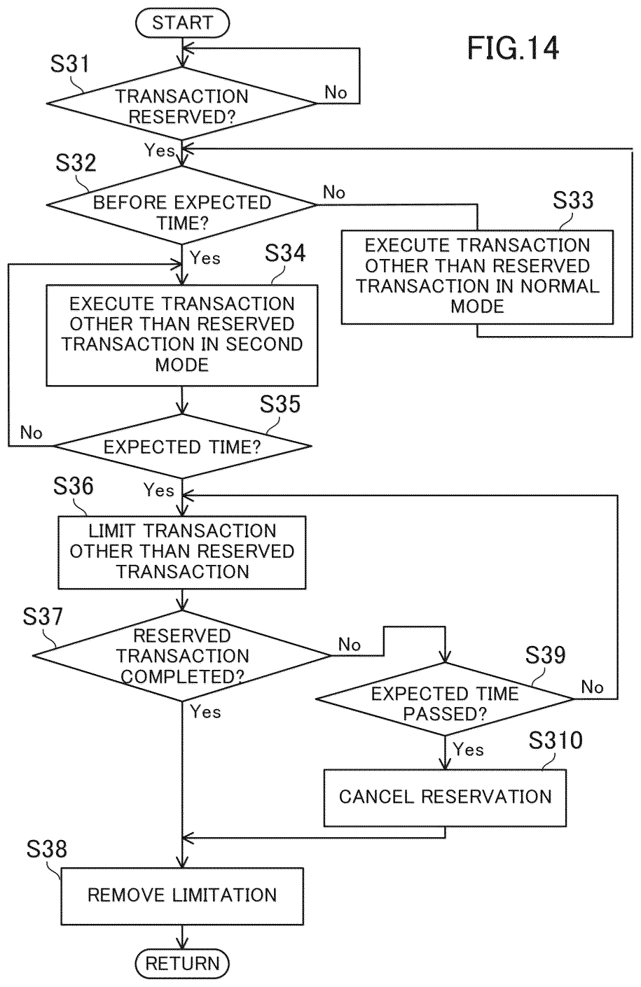

FIG. 14 is a flowchart of the control of the medium processing apparatus 2. Note that in the flowchart of FIG. 14, the order of some steps can be switched, some steps can be omitted, some steps can be replaced with other steps, and other steps can be added in a range possible.

In Step S31 after the start, the medium processing apparatus 2 determines whether or not there is the reserved transaction. That is, the medium processing apparatus 2 determines whether or not the instruction to execute the reserved transaction has been received from the server 11 in Step S14 of FIG. 12 or Step S24 of FIG. 13. In a case there is no reversed transaction, the process repeats Step S31.

In a case where there is the reserved transaction, the medium processing apparatus 2 determines, in Step S32, whether or not it is before the expected time of execution of the reserved transaction. The determination in Step S32 is determination on whether or not the expected time is approaching. The medium processing apparatus 2 may determine Step S32 as Yes if it is a minutes before the expected time. The a minutes can be set as necessary. For example, the a minutes may be set based on the average utilization time of the medium processing apparatus 2 per one client.

In a case where the determination on Step S32 is No, the medium processing apparatus 2 executes, in Step S33, a transaction other than the reserved transaction, i.e., the medium processing related to the second client not related to the reservation, in a normal mode. The process of FIG. 14 returns to Step S32 after Step S33.

In a case where the determination on Step S32 is Yes, the medium processing apparatus 2 executes, in Step S34, a transaction other than the reversed transaction in the second mode.

Here, the second mode is a mode in which the medium processing is promoted to shorten the time required for the medium processing as compared to that in the normal mode.

In the second mode, the medium processing apparatus 2 may perform operation related to the medium processing at a higher speed than that in the normal mode. The medium processing apparatus 2 may increase, as compared to the normal mode, the opening/closing speeds of the shutter 322, the shutter 422, and/or the shutter 512, for example. Moreover, the medium processing apparatus 2 may increase a medium transport speed as compared to the normal mode. Further, the medium processing apparatus 2 may shorten wait time as compared to the normal mode. The wait time is time for which the client waits to perform operation, for example, the client waits to put money. The operation related to the medium processing is performed at a high speed so that the time required for the medium processing can be shortened.

The medium processing apparatus 2 may decrease, in the second mode, the number of items displayed for the client on the display 21 as compared to the normal mode.

The medium processing apparatus 2 may decrease the number of displayed items not directly related to execution of the medium processing by the medium processing apparatus 2. The displayed items to be decreased may include, for example, a displayed item asking the client to input a transaction purpose, such as an item asking the client to select a deposit transaction purpose from options including “deposit of proceeds from sales” and “other deposits.” The decrease in the items displayed on the display 21 causes the client to smoothly perform the operation, and therefore, the time required for the medium processing is shortened.

The medium processing apparatus 2 may limit, in the second mode, the contents of the processing allowed for the client as compared to the normal mode.

The limitation on the contents of the processing includes, for example, limitation of continuous execution of two or more transactions by the client by omitting a step of checking with the client about the necessity of a subsequent transaction after completion of one transaction. The limitation on the contents of the processing further includes a decrease in the upper limit of the number of times of additional deposit as compared to the normal mode and a decrease in the maximum amount of withdrawal as compared to the normal mode. The contents of the processing allowed for the client is limited so that the time required for the medium processing can be shortened.

The execution of the medium processing in the second mode allows the medium processing apparatus 2 to execute the medium processing related to the reserved transaction at the expected time.

In Step S35, the medium processing apparatus 2 determines whether or not the expected time comes. In a case where it is not the expected time yet, the process of FIG. 14 repeats Steps S34, S35. In a case where the expected time comes, the medium processing apparatus 2 limits, in Step S36, a transaction other than the reserved transaction. If the second client other than the client having made reservation attempts to use the medium processing apparatus 2, the medium processing apparatus 2 does not operate. When the client having made reservation arrives at the location of the medium processing apparatus 2, the medium processing apparatus 2 allows the client having made reservation to take out money, for example, by opening the shutter 322, the shutter 422, and/or the shutter 512, as described above. The client having made reservation can execute, at the expected time, the reserved transaction using the medium processing apparatus 2.

In Step S37, the medium processing apparatus 2 determines whether or not the reserved transaction has been completed. In a case where the reserved transaction has been completed, the medium processing apparatus 2 removes the limitation of Step S36 in Step S38. That is, the second client other than the client having made reservation can use the medium processing apparatus 2. Note that after Step S38, the process of FIG. 14 returns to Step S31 and the medium processing apparatus 2 executes the medium processing in the normal mode if it is not before the expected time.

In a case where the reserved transaction is not completed yet in Step S37, the medium processing apparatus 2 determines, in Step S39, whether or not the expected time of the reserved transaction has passed. In a case where the expected time does not pass yet, the medium processing apparatus 2 limits a transaction other than the reserved transaction (Step S36) while waiting for completion of the reserved transaction. Note that “the expected time does not pass yet” as described herein includes a case where delay time set for the expected time in advance does no pass yet. The delay time may be, for example, 15 minutes as described above.

In a case where the expected time has passed in Step S39, the medium processing apparatus 2 cancels the reserved transaction in Step S310, and removes the limitation in Step S38. The second client other than the client having made reservation can use the medium processing apparatus 2. The cancellation of the reserved transaction enhances the efficiency of the operation of the medium processing apparatus 2.

Note that in Step S34, the medium processing apparatus 2 executes the transaction for the second client in the second mode, but instead of or in addition to the execution of the transaction in the second mode, the person in charge of the financial facility may assist the transaction for the second client, thereby promoting the transaction for the second client and quickly completing the transaction. The medium processing system 1 may provide, for example, the tablet 14 with information on the expected time of the reserved transaction. Based on the provided information, the person in charge can assist the transaction for the second client using the medium processing apparatus 2.

The medium processing apparatus 2 may limit execution of a transaction other than the reserved transaction even if it is not the expected time. The medium processing apparatus 2 can compare the contents of the reserved transaction, for example, a withdrawal amount, with the inventory amount of money stored in the storage 36, the storage 45, and/or the storage 52 of the medium processing apparatus 2, thereby determining whether or not the reserved transaction cannot be executed due to an insufficient inventory amount. In a case where there is a probability that the reserved transaction cannot be executed, the medium processing apparatus 2 may limit the execution of the transaction other than the reserved transaction in order not to decrease the inventory amount before the expected time comes.

(Processing in Case where Medium Processing Apparatus Cannot Execute Reserved Transaction)

In the medium processing system 1, the medium processing apparatus 2 starts the medium processing related to the reserved transaction in advance. However, the medium processing apparatus 2 cannot start the medium processing in advance in some cases. For example, the following cases are conceivable: (1) a case where the deposit transaction cannot be executed because the storage 36 and/or the storage 45 of the medium processing apparatus 2 are full or almost full; (2) a case where the withdrawal transaction cannot be executed because the storage 36, the storage 45, and/or the storage 52 of the medium processing apparatus 2 are empty or almost empty; (3) a case where the coin deposit transaction or the coin withdrawal transaction cannot be executed because the medium processing apparatus 2 does not have the coin unit 4 or the coin-roll unit 5; (4) a case where a transaction using a check cannot be executed because the medium processing apparatus 2 does not have the check unit 6; and (5) a case where the withdrawal transaction exceeding the upper limit of withdrawal available in one withdrawal transaction has been reserved for the medium processing apparatus 2.

The server 11 or the medium processing apparatus 2 having received reserved transaction information from the server 11 provides the tablet 14 with the reserved transaction information in a case where the medium processing cannot be started in advance. Based on the information provided to the tablet 14, the person in charge of the financial facility takes necessary measures before the medium processing related to the reserved transaction is executed.

Specifically, in the case (1) where the storage 36 and/or the storage 45 of the medium processing apparatus 2 are full or almost full, the person in charge collects money from the storage 36 and/or the storage 45 of the medium processing apparatus 2. Since the storage 36 and/or the storage 45 become available, the medium processing apparatus 2 can execute the deposit transaction.

In the case (2) where the storage 36, the storage 45, and/or the storage 52 are empty or almost empty, the person in charge refills the storage 36, the storage 45, and/or the storage 52 of the medium processing apparatus 2 with money. Since the money is stored in the storage 36, the storage 45, and/or the storage 52, the medium processing apparatus 2 can execute the withdrawal transaction.

In the case (3) where the medium processing apparatus 2 does not have the coin unit 4 or the coin-roll unit 5, for example, a coin to be withdrawn is prepared in advance at the counter. When the client having made reservation visits the service office 12, the teller deposits or withdraws the coin at the counter.

In the case (4) where the medium processing apparatus 2 does not have the check unit 6, the teller handles a check at the counter when the client having made reservation visits the service office 12.

In the case (5) where the withdrawal transaction exceeding the upper limit of withdrawal available in one withdrawal transaction has been reserved for the medium processing apparatus 2, the person in charge withdraws money in advance using the medium processing apparatus 2 or other apparatuses, and when the client having made reservation visits the service office 12, hands over the money to the client at the counter.

Note that in the case (3), (4), or (5), the medium processing system 1 may notify the client terminal 16 to visit the counter of the service office 12.

The person in charge of the financial facility takes appropriate measures so that the reserved transaction can be executed without keeping the client waiting, and therefore, the degree of satisfaction of the client can be enhanced.

### (Cooperation of Medium Processing Apparatus and Other Apparatuses)

In a case where the medium processing apparatus 2 cannot execute the reserved withdrawal transaction while another apparatus different from the medium processing apparatus 2 can execute the withdrawal transaction, the medium processing apparatus 2 may guide the client having made reservation to the withdrawal transaction using the another apparatus.

Specifically, the display 21 of the medium processing apparatus 2 provides a guidance to the withdrawal transaction using the another apparatus, and the first printer 26 or the second printer 27 outputs a receipt or paper on which a code is printed. The code is a code for identifying the reserved transaction.

The client having received the receipt causes a code reader of the specified another apparatus to read the code. The another apparatus performs the medium processing corresponding to the reserved transaction, here money withdrawal.

Immediately before the client having made reservation performs the withdrawal transaction using the medium processing apparatus 2, even in a case where the storage 36, the storage 45, and/or the storage 52 becomes empty or almost empty due to a transaction for the second client, the client having made reservation is guided to the another apparatus, and therefore, the reserved transaction can be completed without keeping the client waiting long. As a result, the degree of satisfaction of the client of the medium processing system 1 is enhanced.

Note that the medium processing apparatus 2 of the medium processing system 1 as described above is an example. Medium processing apparatuses 2 with various structures or in various forms are applicable to the medium processing system 1 and the medium processing method disclosed here.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. The processor may be a programmed processor which executes a program stored in a memory. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

What is claimed is:

1. A medium processing method comprising:
receiving, by a server, a reservation set by a client for a transaction including medium processing by a medium processing apparatus;
starting, by the medium processing apparatus, the medium processing corresponding to the transaction related to the reservation based on first information related to relative locations of the client and the medium processing apparatus; and
allowing, by the medium processing apparatus, the client to handle a medium in the medium processing apparatus based on second information related to the relative locations, thereby completing the transaction related to the reservation.

2. The medium processing method of claim 1, wherein
the second information is acquired at timing after that of the first information.

3. The medium processing method of claim 1, wherein
the relative locations of the client and the medium processing apparatus in the second information are closer to each other as compared to the relative locations of the client and the medium processing apparatus in the first information.

4. The medium processing method of claim 1, wherein
the transaction is a withdrawal transaction, and
in the withdrawal transaction, the medium processing apparatus dispenses money to an outside thereof.

5. The medium processing method of claim 4, wherein
the medium processing apparatus starts, based on the first information, transporting money from an inside to the outside thereof.

6. The medium processing method of claim 5, wherein
the medium processing apparatus has a holder that holds money to be dispensed to the outside thereof and a shutter that opens and closes an outlet port of the holder, and
the medium processing apparatus closes the shutter while transporting money to the holder, and opens the shutter when the client is allowed to take out money from the holder based on the second information.

7. The medium processing method of claim 1, wherein
the transaction is a money change transaction, and
in the money change transaction, the medium processing apparatus takes money of the client therein, and dispenses money, which is equivalent to the taken money, to an outside thereof.

8. The medium processing method of claim 7, wherein
the medium processing apparatus has a feeder that feeds money therein, a dispenser that holds money to be dispensed to an outside thereof, and a shutter that opens and closes an outlet port of the dispenser,
the medium processing apparatus starts transporting money therein to the dispenser based on the first information, and closes the shutter while transporting money to the dispenser, and
the medium processing apparatus allows the client to feed money into the medium processing apparatus through the feeder based on the second information, and opens the shutter when the client is allowed to take out money from the dispenser after money has been taken in.

9. The medium processing method of claim 1, wherein
the transaction is a deposit transaction, and
in the deposit transaction, the medium processing apparatus takes money of the client therein.

10. The medium processing method of claim 1, wherein
the reservation includes an expected time at which the client handles money using the medium processing apparatus, and
the medium processing apparatus starts, before the expected time, the medium processing corresponding to the transaction related to the reservation.

11. The medium processing method of claim 10, wherein
in a case where the medium processing apparatus executes medium processing related to a second client not related to the reservation before the expected time, the medium processing apparatus executes the medium processing in a second mode in which a time required for the medium processing is shortened as compared to a normal mode.

12. The medium processing method of claim 11, wherein
the medium processing apparatus performs, in the second mode, operation related to the medium processing at a higher speed than that of the normal mode.

13. The medium processing method of claim 11, wherein
the medium processing apparatus decreases, in the second mode, the number of items displayed for the second client on a display as compared to the normal mode.

14. The medium processing method of claim 11, wherein
the medium processing apparatus limits, in the second mode, a content of processing allowed for the second client as compared to the normal mode.

15. The medium processing method of claim 10, wherein
the medium processing apparatus limits a client performing a transaction at the expected time only to the client related to the reservation.

16. The medium processing method of claim 15, wherein
in a case where the transaction of the client related to the reservation is not completed even after the expected time has passed, the medium processing apparatus cancels the transaction related to the reservation, and removes the limitation.

17. The medium processing method of claim 1, wherein
the first information and the second information are acquired using a communication function of a mobile terminal held by the client.

18. The medium processing method of claim 1, wherein
the first information is acquired using a communication function of a mobile terminal held by the client, and the second information is acquired using a sensor of the medium processing apparatus.

19. The medium processing method of claim 17, wherein
the medium processing apparatus has control circuitry that controls the medium processing apparatus, and
based on acquisition of information on the transaction related to the reservation from the server by the control circuitry and acquisition of the first information from the mobile terminal by the control circuitry, the medium processing is started by the control circuitry.

20. A medium processing system comprising:
a medium processing apparatus that executes a transaction including medium processing; and
a server that receives a reservation set by a client for the transaction executed by the medium processing apparatus,
wherein the medium processing apparatus starts the medium processing corresponding to the transaction related to the reservation based on first information related to relative locations of the client and the medium processing apparatus, and
the medium processing apparatus allows the client to handle a medium in the medium processing apparatus based on second information related to the relative locations, thereby completing the transaction related to the reservation.
